(19) United States
(12) Patent Application Publication
(10) Pub. No.: US 2002/0188666 A1
(43) Pub. Date: Dec. 12, 2002

(54) Lightweight dynamic service conversation controller

(76) Inventors: Michael J. Lemon, Palo Alto, CA (US); Harumi A. Kuno, Cupertion, CA (US); Alan H. Karp, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 09/862,612

(22) Filed: May 23, 2001

(51) Int. Cl. G06F 15/16

(52) U.S. Cl. 709/203

(57) ABSTRACT

A mechanism provides for a conversation controller that enables services to carry out an entire conversation without the service developers having to implement code to manage conversation logic. The mechanism focuses on conversation functionality as opposed to business functionality of the service and enables service developers to delegate conversational responsibilities to the conversation controllers thus freeing the developers from having to implement explicit conversation control mechanisms and allowing the services to interact without having to explicitly support conversations. These distinctions help to provide an extremely lightweight conversation controller capable of directing a service's conversations with other services or clients.

### TECHNICAL FIELD

The technical field relates to E-Services communication.

### BACKGROUND

Distributed computing has evolved from intra-enterprise application integration, where application developers work together to develop and code to agreed upon method interfaces, to inter-enterprise integration, where E-Services may be developed by independent enterprises with completely disjoint computing infrastructures. To accommodate the change, E-Services, which may include services, agents, and web-services, should be able to communicate and exchange business data in a meaningful way, and having some degree of flexibility and autonomy with regard to the interactions.

Several existing agent systems allow services/agents to communicate following conversational protocols. However, all of these agent systems are tightly coupled to specific service/agent systems, and require that all participating entities built upon a common service/agent platform.

For example, Bradshaw, J. M. provides an open distributed architecture for software agents, the Knowledgeable Agent-oriented System (KAoS), in the 1996 issue of “Knowledge Acquisition for Knowledge-Based Systems Workshop,” entitled “KaoS. An Open Agent Architecture Supporting Reuse, Interoperability, and Extensibility.” However, KAoS requires agent developers to hard-wire conversation policies into agents in advance.

Walker, A. and Wooldridge, M. address the issue of how a group of autonomous agents can reach a global agreement on conversation policy in the 1995 issue of “First International Conference on Multi-Agent Systems,” entitled “Understanding The Emergence Of Conventions In Multi-Agent Systems.” However, Walker and Wooldridge require the agents themselves to implement strategies and control.

Chen, Q., Dayal, U., Hsu, M., and Griss, M. provide a framework in which agents can dynamically load conversation policies from one-another in the 2000 issue of “First International Conference on E-Commerce and Web-Technology,” entitled “Dynamic Agents, Workflow and XML for E-Commerce Automation.” But Chen, et al.'s solution is homogeneous and requires that agents be built upon a common infrastructure.

A few E-Commerce systems also support conversations between services. However, these systems all require that the client and service developers implement matching conversation control policies.

For example, RosettaNet's Partner Interface Processes (PIPs) specify roles and required interactions between two businesses, while Commerce XML (cXML) is a proposed standard being developed by more than 50 companies for business-to-business electronic commerce. However, both RosettaNet and CommerceOne require that participating services pre-conform to their standards.

To illustrate, in an E-Service marketplace with two different enterprises, a client service in one enterprise may have discovered a storefront service in another enterprise. In order to complete a sale, a credit validation service in yet another enterprise may be employed by the storefront service to make sure that the client is credible. These services can communicate by exchanging messages using common transports and message formats. The storefront service may expect that message exchanges, i.e., the conversation, to follow a specific pattern. So does the credit validation service. Because the client and the storefront services belong to different enterprises and have discovered each other dynamically, the client service may not know what conversations the storefront service supports. Similarly, the credit validation service may not know what conversations the client service or the storefront service supports. Accordingly, explicit conversation control implementation may be needed to conduct a conversation between the client service and the storefront service, between the client service and the credit validation service, and between the storefront service and the credit validation service.

Accordingly, current conversation systems require participating service developers to implement logic code to adhere strictly to pre-defined conversation policies. Should a conversation protocol change, all participating services that support the protocol must be updated and recompiled, reducing the likelihood that two services that discover each other will be able to converse spontaneously.

### SUMMARY

A mechanism for implementing a conversation between two services provides for a conversation controller that may act as a proxy to an E-Service, enabling the service to engage in complex interactions with other services without the service developers having to implement code to manage conversation logic. Once the conversation controller receives a message, typically from a client, on behalf of a service, the conversation controller may determine a current state of the conversation and a valid input document type for the current state, verify whether the message is of the valid input document type for the current state, and dispatch the message to appropriate service entry points provided by the service, until the service produces an output document of a valid output document type.

An embodiment of the mechanism may also direct the client's side of a conversation, so that the client and the service may carry out an entire conversation without either the client or the service developer having to implement any explicitly conversation control mechanisms.

An embodiment of the mechanism may also apply a transformation to output documents, for example, transforming the output documents to a hypertext markup language (HTML) form.

### DESCRIPTION OF THE DRAWINGS

The preferred embodiments of a conversation controller will be described in detail with reference to the following figures, in which like numerals refer to like elements, and wherein:

FIG. 1 is a flow chart demonstrating how an exemplary conversation controller receives and manages a message on behalf of a service;

FIG. 2 illustrates how the exemplary conversation controller directs a client's side of a conversation;

FIG. 3 is a block diagram illustrating the components of the exemplary conversation controller;

FIG. 4 illustrates in detail how the exemplary conversation controller manages a message on behalf of a service;

23 FIG. 5 shows an example demonstrating how service developers may be able to engage in inter-enterprise conversation without having to implement explicit conversation control; and

FIG. 6 illustrates exemplary hardware components of a computer that is used to implement the present invention.

### DETAILED DESCRIPTION

E-Services interact by exchanging messages. Each message can be expressed as a structured document that is an instance of a document type. For example, a message may be expressed using extensible markup language (XML) schema. The message may be wrapped in an encompassing document, which can serve as an envelope that adds contextual information using, for example, Simple Object Access Protocol (SOAP). SOAP is a lightweight protocol for exchange of information in a decentralized, distributed environment. SOAP consists of three parts: an envelope that defines a framework for describing what is in a message and how to process the message, a set of encoding rules for expressing instances of application-defined datatypes, and a convention for representing remote procedure calls and responses. SOAP can potentially be used in combination with a variety of other protocols.

A conversation may be a sequence of message exchanges between two or more services. Conversations typically model loosely-coupled interaction between services, rather than workflow processes. In another words, conversations typically define externally visible commerce processes instead of business logic, and are typically transactional only at the end of the conservation. A conversation specification, also known as a conversation policy, may be a formal description of a set of “legal” message type-based conversations supported by a service.

Instead of requiring service developers to implement logic code to adhere strictly to pre-defined conversation policies, a mechanism provides for a conversation controller that enables services to carry out an entire conversation without the service developers having to implement code to manage conversation logic.

The mechanism focuses on conversation functionality, such as flow control and other routines of the conversation, as opposed to business functionality of the service, such as quality of service and other management of the conversation. The mechanism enables service developers to delegate conversational responsibilities to the conversation controller, thus freeing the developers from having to implement explicit conversation control mechanisms and allowing the services to interact even if the services don't support precisely matching conversations. These distinctions help to provide an extremely lightweight conversation controller capable of directing a service's conversations with other services or clients. The conversation controller may dynamically execute a service's conversation logic given a minimum amount of information. The conversation controller may also control a client's side of the conversation.

The mechanism may be completely compatible with existing E-Commerce systems that support conversations between E-Services, such as RosettaNet's Partner Interface Processes (PIPs) and Commerce XML (cXML).

The conversation controller is a third party service that is capable of facilitating a conversation between two other services. The conversation controller may act as a proxy to services and track the state of an ongoing conversion based on a conversation definition language specification. The conversation controller may also invoke appropriate service and/or client entry points based on dispatch service description language specifications and prompt for valid input document types for a given state of a conversation, thus enabling the services and clients to engage in complex interactions with each other.

Once the conversation controller receives a message on behalf of a service, the conversation controller may validate that each message is of an appropriate input document type for the current state of the conversation and dispatch the message to the appropriate service entry point based on the state of the conversation and the message's type. The conversation controller may use the resulting output document types to identify the next appropriate interaction for the conversation, and may include a prompt indicating valid document types that are accepted by the next stage of the conversation when forwarding a response from the service to the client. The prompt may optionally be filtered through a transformation appropriate to the client's type. For example, if the client is a web browser and has indicated a preference for form output, the conversation controller may transform the response into an HTML form before sending the response to the client. In addition, if the client requests and specifies appropriate entry points, the conversation controller may direct the client's side of the conversation (described later), so that neither the service nor the client developer may need to implement any explicit conversation control mechanism.

When a conversation proceeds from one state to another, a “state” of the conversation, which contains information of the current state, may need to be tracked. If the conversation controller maintains the state of the conversation, the conversation controller may be referred to as stateful. However, if the “state” of the conversation is carried in the message and passed from the client and the server to the conversation controller, the conversation controller may be referred to as stateless. A stateless conversation controller may be easier to implement, while a stateful conversation controller may be extended to implement performance management, conversation history, or rollback mechanisms, and thus may be more effective in handling issues such as malicious behavior on the part of one of the participants.

In order for a service to use the conversation controller as a proxy, the service may need to communicate two documents, typically XML-based, to the conversation controller. The first document to be communicated may be a conversation specification, i.e., a specification of the structure of the conversations supported by the service. The second document to be communicated may be a document-based specification mapping valid input document types and service entry points to potential output document types.

Accordingly, a developer of the service may need to document the service's conversation flow in a specification, document the type-based inbound handling entry points in a specification that preferably capture both input and output document types, and advertise the service with an entry point going through the conversation controller.

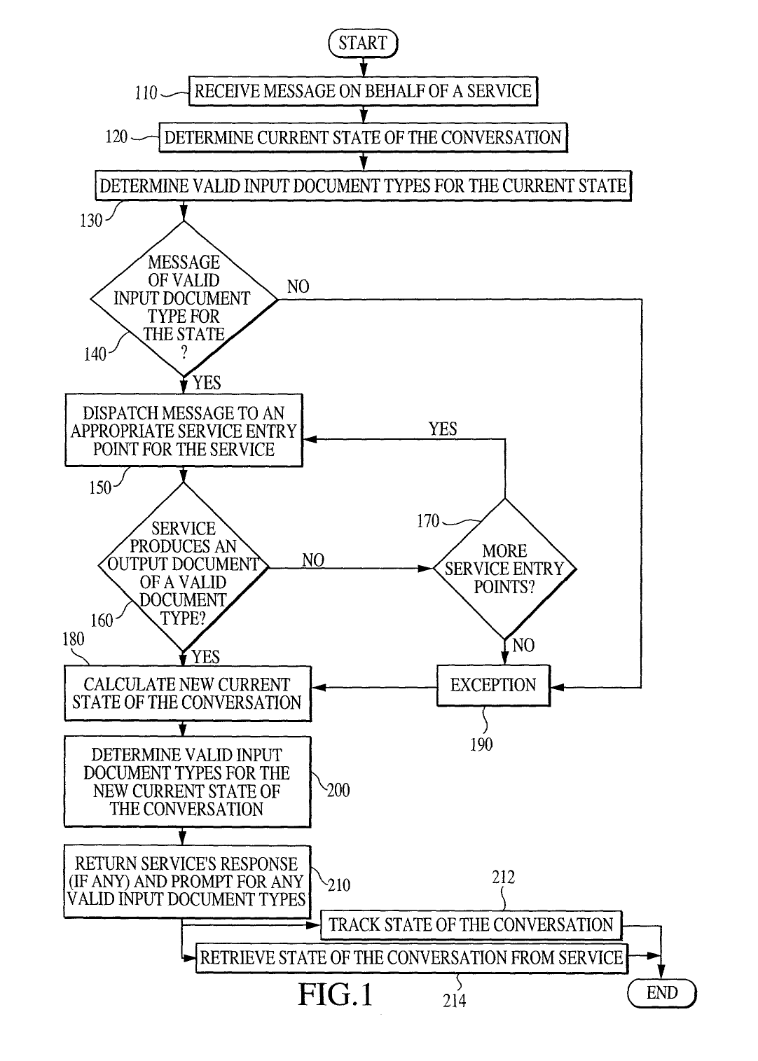

FIG. 1 is a flow chart demonstrating in general how the conversation controller receives and manages a message on behalf of the service. After the conversation controller receives a message on behalf of a service, step 110, the conversation controller may determine a current state of the conversation, step 120. The conversation controller may ask the service for conversation specifications, if necessary. Next, the conversation controller may determine the valid input document types for the current state from the conversation specifications, step 130, and verify whether the current message is of a valid input document type for the current state, step 140.

If the received message is of a valid type, the conversation controller may dispatch the message to an appropriate service entry point provided by the service, step 150. If the service does not produce an output document of a valid document type, step 160, and if more than one appropriate service entry point exists, step 170, the conversation controller may dispatch the message to each entry point, step 150, until the service produces an output document of a valid document type. If no entry point exists or no valid output document is produced, the conversation control may raise an exception, step 190.

Given the document type of the output document returned by the service, step 160, the conversation controller may calculate a new state of the conversation, step 180, and determine valid input document types for the new state of the conversation, step 200.

Finally, the conversation controller may format the output document in a form appropriate to the client and prompt for new input document types that are valid in the new state, step 210, for a new interaction. In step 210, the conversation controller may apply requested transformations to the output document, for example, transforming the output document into an HTML form and prompting the client for valid input documents.

The conversation controller may maintain and track the “state” of the conversation, i.e., implemented as stateful, step 212, or may retrieve the “state” of the conversation from the service, i.e., implemented as stateless, step 214.

E-Service clients may also want the conversation controller to direct the client's side of the conversation. Decoupling conversation logic from business logic on the client side may greatly increase the flexibility of a client by allowing the client to interact dynamically with services even if the client's and the services' conversation policies do not match exactly. For example, the same client code may be used to interact with two services that support different conversation policies.

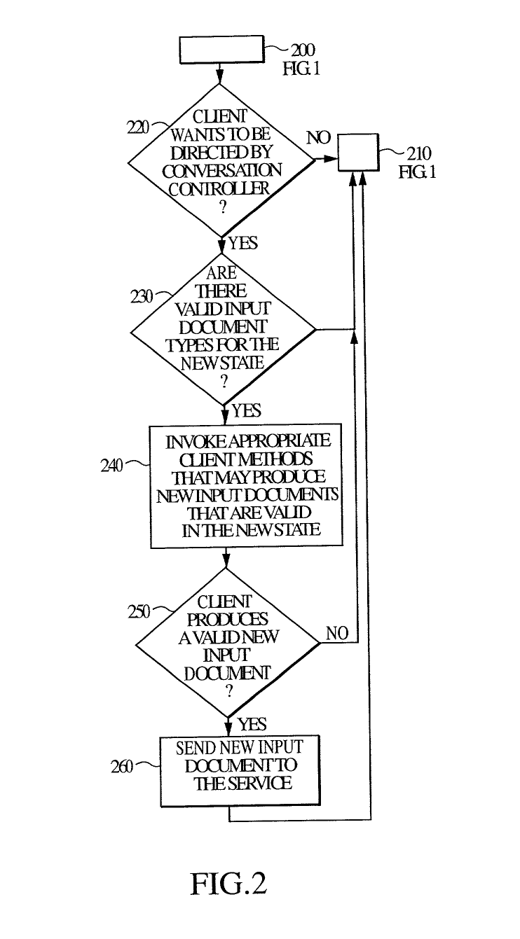

FIG. 2 illustrates in general how the conversation controller directs a client's side of a conversation. In order for the conversation controller to direct the client's side of the conversation, the client, typically a web browser client that can return a specification of the client's own service entry points, may need to be able to communicate the client's service interfaces to the conversation controller, so that the conversation controller may automatically send the output message to appropriate client entry points.

Referring to FIG. 2, following step 200 of FIG. 1, if the client wishes to be directed by the conversation controller, step 220, and there are valid input document types for the new state, step 230, the conversation controller may look up outbound document types in a dispatch table of the client, and invoke appropriate client methods that may produce new input documents that are valid in the new state, step 240.

If the client produces the new input documents that are valid in the new state, step 250, the conversation controller may send the new input documents to the service, step 260, moving the conversation forward dynamically.

On the other hand, if the client does not produce any valid new input documents, step 250, or if there are no valid new input document types in the new state, step 230, the conversation controller may format and return the output document to the client, and prompt for new input document types that are valid in the new state, step 210 of FIG. 1.

Therefore, the lightweight dynamic conversation controller, acting as a proxy for the service and/or the client, can help multiple services carry out an entire conversation without either the client or the service developer having to implement any explicit conversation control mechanisms, so that a developer of the client may not need complete knowledge of all of the possible conversations supported by all the services with which the client might interact in the future.

In order to track the state of conversations, the conversation controller may perform the following functions. Given a message, the conversation controller may determine the conversation specification that represents the type of conversation, an interaction identifier that represents the stage of the ongoing conversation, and document type of the message body.

In order to accomplish these functions, the conversation controller may give each message a special context element, such as the following:

```
<Context>
  <ConversationID/>
  <In-Reply-To/>
  <Reply-With/>
</Context>
```

Each of these elements may have an “owner” that controls the contents of the element value. The conversation controller, for example, may own the ConversationID field, which may be used to map the current interaction and the valid input document types for the current interaction of the current conversation to the conversation type identifier. A message sender, for example, may own the Reply-With element. The In-Reply-To elements's value may be the value of the Reply-With element of the message to which the current message is responding.

In addition to the above described function, given a conversation specification and an interaction identifier, the conversation controller may return document types that are accepted as valid input to that interaction. Furthermore, given a conversation specification, an interaction identifier from the specification, and a document type representing an input document, the conversation controller may return a boolean signal indicating whether or not the document type may be accepted as a valid input for that interaction. Similarly, given a conversation specification, a source interaction identifier from the specification, and a document type representing an output document, the conversation controller may return a target interaction represented by the transition from the source interaction.

These functions may be satisfied, for example, by populating two hash tables each time when the conversation controller reads a new conversation specification expressed, for example, in CDL. One table may map from interaction identifiers to valid input document types and another table may map from source interaction identifier and transition document types to target interaction identifiers. The conversation controller may use the first table to look up the valid input document types for a given interaction, and use the second table to determine when a conversation has progressed from one interaction state to another, given the document type of an output document and a source interaction identifier.

As another example, in order to forward messages to appropriate service entry points, an endpoint binding specification, for example, a WSDL specification, may be created for each service so that the conversation controller may map input and output document types to service entry points. Each time the conversation controller reads a specification, the conversation controller may populate another two hash tables: one that maps from input document types to service entry point and output document types, and one that maps from output document types to service entry point and input document types.

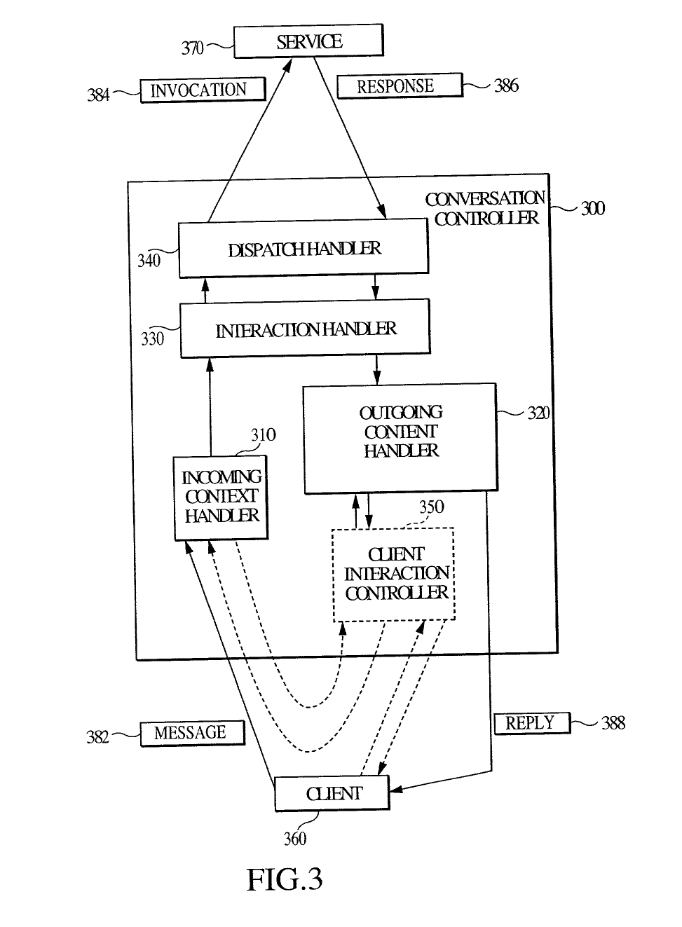

FIG. 3 is a block diagram illustrating the components of a conversation controller 300, from the perspective of how the conversation controller 300 manages messages from a client 360 to a service 370. An incoming context handler 310 may include a logic that manages message structure, and may be responsible for restoring contextual information packed in incoming message headers to its original format. An outgoing content handler 320 maybe responsible for packing contextual information into outgoing message headers and composing outgoing messages. An interaction handler 330 may parse and query conversation definitions to, for example, validate document types or calculate new conversation states. The interaction handler 330 may also raise exceptions when an invalid type document is received. A dispatch handler 340 may parse and query service descriptions, typically specified in WSDL, and use the service descriptions to forward messages to the service 370. An optional client interaction controller handler 350 and interactions, drawn with dotted lines, may dispatch a reply from the service 370 to the client 360 and then forward the client's response back to the service 370 by way of the conversation controller 300.

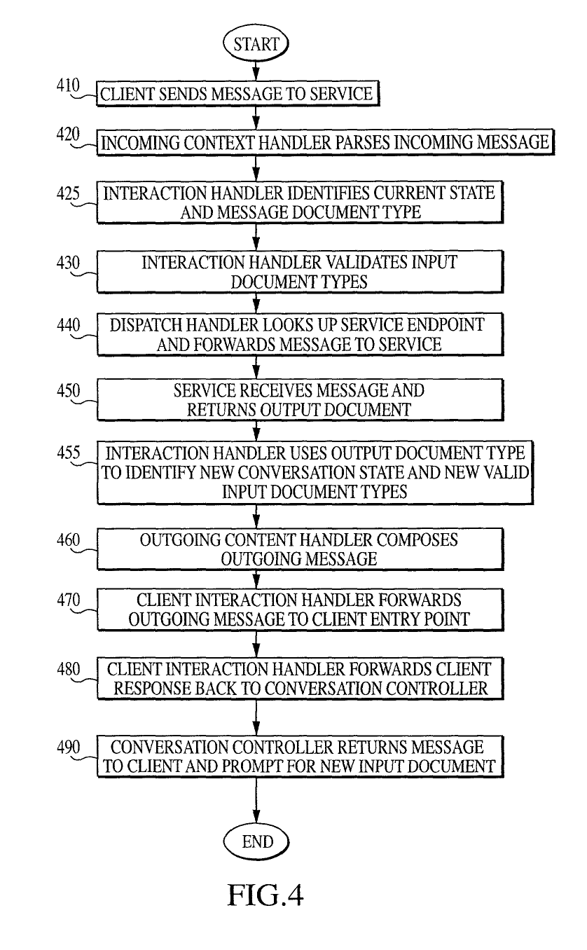

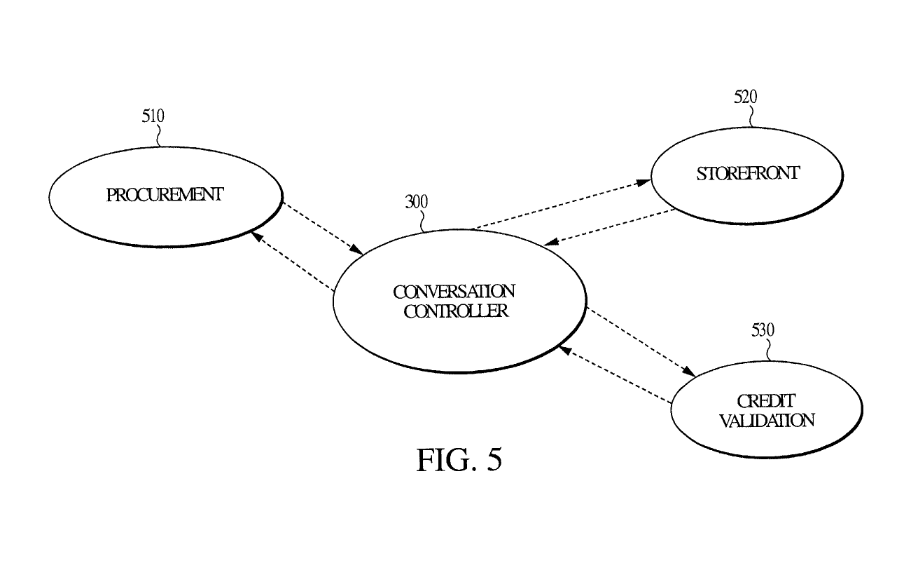

FIG. 4 illustrates in detail how the conversation controller 300 manages a message on behalf of a service 370. Each time the conversation controller 300 receives a message on behalf of the service 370, step 410, the incoming context handler 310 may parse the incoming message, and extract or initialize the message's context data, step 420. The interaction handler 330 may use the data to identify the current state, conversation specification, typically specified in CDL, and document type represented by the incoming message, 425. Then the interaction handler 330 may validate whether or not the document type of the incoming message is valid for the current state, step 430.

If the incoming message is of a legitimate type, the dispatch handler 340 may parse the service's specification and forward the message to an appropriate service entry point, step 440. If the message's type is not legitimate, the conversion controller may trigger an appropriate exception transition, typically defined in advance, and inform the client of the valid input document types. When the service 370 returns a response message, i.e., output document, step 450, the interaction handler 330 may use the document type of the response message and the conversation specification to identify a new state of the conversation as well as the new state's valid input document types, step 455. If the response document type is not valid, the conversation controller may take exception transitions into account. The outgoing content delivery handler 320 may build an outgoing message context element from the response message, and compose an outgoing message to return to the client 360, step 460.

If the client service has requested that the conversation controller direct the client's side of the conversation and has provided a specification for the client 360 itself, the client interaction handler 350 may identify and dispatch to an appropriate client entry point that may produce an appropriately typed document using the client specification, step 470. If the client 360 produces a valid document for the new state, the client interaction handler 350 may forward the message back to the conversation controller 300 and start a new cycle, step 480.

Finally, the conversation controller 300 may return the message back to the client 360 and prompt for next legal input document, step 490.

FIG. 5 illustrates how service developers may be able to engage in inter-enterprise conversation without having to implement explicit conversation control. In the example illustrated above in the background section, a client 510 service in one enterprise may have discovered a storefront 520 service in another enterprise. In order to complete a sale, a credit validation 530 service in yet another enterprise may be employed by the storefront 520 service to make sure that the client 510 is credible.

By using a conversation controller 300, the storefront 520 service developer may be freed from having to code the conversation-controlling logic directly into the service or to re-implement the client 510 and storefront 520 services each time a new message exchange is added to the supported conversation. The conversation controller 300 may also free the credit validation 530 service from having to implement logic code to adhere strictly to pre-defined conversation policies established by either the storefront 520 service or the client 510 service.

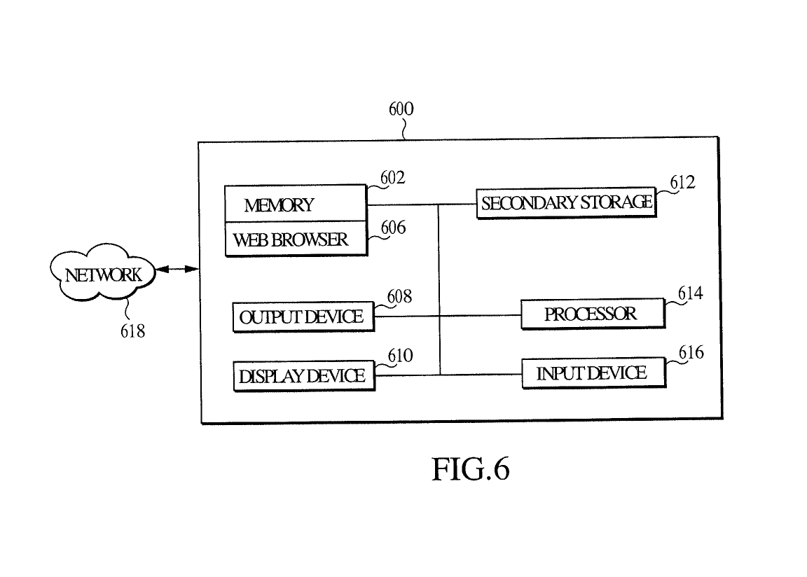

FIG. 6 illustrates exemplary hardware components of a computer 600 that may be used with the conversation controller. The computer 600 includes a connection with a network 618 such as the Internet or other type of computer or phone networks. The computer 600 typically includes a memory 602, a secondary storage device 612, a processor 614, an input device 616, a display device 610, and an output device 608.

The memory 602 may include random access memory (RAM) or similar types of memory. The memory 602 may be connected to the network 618 by a web browser 606. The web browser 606 makes a connection by way of the WWW to other computers known as web servers, and receives information from the web servers that is displayed on the computer 600. Information displayed on the computer 600 is typically organized into pages that are constructed using specialized language, such as HTML or XML. The secondary storage device 612 may include a hard disk drive, floppy disk drive, CD-ROM drive, or other types of non-volatile data storage, and may correspond with various databases or other resources. The processor 614 may execute information stored in the memory 602, the secondary storage 612, or received from the Internet or other network 618. The input device 616 may include any device for entering data into the computer 600, such as a keyboard, key pad, cursor-control device, touch-screen (possibly with a stylus), or microphone. The display device 610 may include any type of device for presenting visual image, such as, for example, a computer monitor, flat-screen display, or display panel. The output device 608 may include any type of device for presenting data in hard copy format, such as a printer, and other types of output devices include speakers or any device for providing data in audio form. The computer 600 can possibly include multiple input devices, output devices, and display devices.

Although the computer 600 is depicted with various components, one skilled in the art will appreciate that the computer can contain additional or different components. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling the computer 600 to perform a particular method.

While the conversation controller has been described in connection with an exemplary embodiment, it will be understood that many modifications in light of these teachings will be readily apparent to those skilled in the art, and this application is intended to cover any variations thereof.

What is claimed is:

1. A method for implementing a conversation between a client and a service, comprising:
receiving a message on behalf of the service;
determining a current state of the conversation;
determining valid input document types for the current state;
verifying whether the message is of one of the valid input document types for the current state; and
dispatching the message to appropriate service entry points provided by the service, until the service produces an output document of a valid output document type.

2. The method of claim 1, wherein if messages of invalid input documents types are received, further comprising raising exceptions.

3. The method of claim 1, wherein if no valid output document is produced by the service, further comprising raising exceptions.

4. The method of claim 1, further comprising formatting and returning to the client the output document in a form appropriate to the client.

5. The method of claim 1, further comprising:
calculating a new state of the conversation from the valid output document type;
determining new input document types that are valid in the new state; and
prompting for the new input document types that are valid in the new state.

6. The method of claim 1, wherein the determining the current state step includes asking the service for conversation specifications.

7. The method of claim 1, further comprising maintaining a “state” of the conversation.

8. The method of claim 1, further comprising retrieving a “state” of the conversation from the service.

9. The method of claim 1, further comprising:
calculating a new state of the conversation from the valid output document type; and
invoking client methods that can produce new input documents that are valid in the new state.

10. The method of claim 9, further comprising sending the new input documents to the service.

11. A conversation controller that implements a conversation between a client and a service, comprising:
an incoming context handler that receives a message on behalf of the service, wherein the incoming context handler is capable of parsing the message and extracting a document type of the message;
an interaction handler coupled to the incoming context handler and capable of identifying a current state, conversation specifications and the document type of the message from the message; and
a dispatch handler coupled to the interaction handler, wherein the dispatch handler parses the conversation specification and forwards the message to service entry points of the service.

12. The conversation controller of claim 11, wherein the interaction handler validates if the document type of the message is valid for the current state.

13. The conversation controller of claim 11, wherein the interaction handler calculates a new state of the conversation and new valid document types for the new state from a response returned by the service.

14. The conversation controller of claim 13, further comprising an outgoing content handler capable of constructing an outgoing message that is valid for the new state, wherein the outgoing content handler returns the outgoing message to the client.

15. The conversation controller of claim 11, further comprising a client interaction handler that dispatches a reply from the service to the client and forwards a response from the client to the service.

16. A computer readable medium comprising instructions for implementing a conversation between a client and a service, the instructions comprising:
receiving a message on behalf of the service;
determining a current state of the conversation;
determining valid input document types for the current state;
verifying whether the message is of one of the valid input document types for the current state; and
dispatching the message to appropriate service entry points of the service, until the service produces an output document of a valid output document type.

17. The computer readable medium of claim 16, further comprising formatting and returning to the client the output document in a form appropriate to the client.

18. The computer readable medium of claim 16, further comprising:
calculating a new state of the conversation from the valid output document type;
determining new input document types that are valid in the new state; and
prompting for the new input document types that are valid in the new state.

19. The computer readable medium of claim 16, wherein if messages of invalid document types are received, further comprising raising exceptions.

20. The computer readable medium of claim 16, wherein if no valid output document is produced by the service, further comprising raising exceptions.
